(19) United States
(12) Patent Application Publication
(10) Pub. No.: US 2005/0210608 A1
(43) Pub. Date: Sep. 29, 2005

(54) Automatic loader for foam pellet cleaning system

(76) Inventors: William O. Walters, Seattle, WA (US); Mark R. Weber, Seattle, WA (US)

Correspondence Address: Tyrone Davis;c/o Davis & Kendall, P.C., Suite 1245, 205 West Randolph, Chicago, IL, 60606, US

(21) Appl. No.: 10/808,634

(22) Filed: Mar. 25, 2004

(51) Int. Cl. B08B 9/055

(52) U.S. Cl. 15/3.5; 15/104.062

(57) ABSTRACT

A method and system for automatically loading foam pellets which clean fluid carrying passages, such as hydraulic tubing, into a pneumatic launcher. The pellets are automatically transferred from a storage sleeve into the pneumatic launcher for subsequent propulsion through the tubing. Interior walls of the passages are scrubbed clean as the pellets pass therethrough. In addition, the method and system can easily convert a conventional foam cleaning pellet pneumatic launcher from a manual loading operation to a fully automatic loading operation, thereby increasing overall productivity of the cleaning operation.

### BACKGROUND OF THE INVENTION

1. Field of the Invention

The present invention pertains to fluid carrying tube cleaning systems, particularly foam pellet tube cleaning systems.

2. Discussion of the Related Art

Organic vapor cleaning methods have long been used in the fluid power industry to clean the interior of fluid carrying tubing, such as hydraulic tubing. Unfortunately, typical organic-vapor cleaning methods often have high capital equipment costs, are expensive to implement and require adherence to government air quality regulations.

As an alternative, foam pellet cleaning of fluid carrying tubing is widely used, and has proven to be an effective and easy way to replace organic-vapor cleaning methods.

Briefly described, foam pellet cleaning systems call for using compressed air to propel one or more cylindrically shaped foam rubber cartridges through the tubing to be cleaned. Fric-tional contact between the interior tubing walls and the pellet, cleans the walls as the pellet passes therethrough.

Currently available equipment for foam pellet cleaning usually requires manual loading of the cleaning pellets, one at a time, into a pneumatic launcher device. The pellets are inserted into a feed-tube brought up to the muzzle of the pneumatic launcher, and then fired from the launcher into the fluid carrying tube to be cleaned.

Clearly, manual loading of the cleaning pellets into the pneumatic launcher in serial fashion is not suitable for use in a high production rate factory environment, due to the fact that this approach requires too many manual operations to take full advantage of time and labor in the most economical manner.

Hence, in view of the fact that manually loaded foam pellet cleaning equipment is too slow and labor intensive to be cost effective, the need for an automatic loading foam pellet cleaning system has arisen.

### SUMMARY OF THE INVENTION

The present invention provides an automatic loader for a foam pellet cleaning system including a pellet propeller, the automatic loader having a vertically mounted, tubular-shaped multiple pellet reservoir having an entrance port at its top end, an exit port on its lower end, and an opening proximate the exit port; an L-shaped crank pivotally mounted between the exit port and the proximate opening, the crank having a first end operable to block discharge of a pellet from the exit end of the reservoir, and a second end operable for intrusion into the proximate opening; such that pivotal operation of the crank causes the first end to unblock the exit end of the reservoir allowing discharge of a pellet from the reservoir into the pellet propeller, while simultaneously intruding the second end into the proximate opening to prevent premature discharge of a second pellet from the exit end into the propeller.

Another advantage of the present invention is to provide a method for operating an automatic pellet loader for a foam pellet cleaning system having a pellet launcher, by filling a cleaning pellet dispenser having a pivotal crank with a plurality of pellets; actuating the crank to permit one pellet at a time to be dispensed from the dispenser upon command, and loading a dispensed pellet into the launcher of the cleaning system.

Another advantage of the present invention is to provide a system for cleaning interior passages of fluid carrying tubing using foam pellets comprising a vertically mounted pellet retaining sleeve having an entrance port at its top end, an exit port on its lower end, and an opening proximate the exit port; an L-shaped crank having a first projection on one end which blocks discharge of a pellet from the exit end of the sleeve, a second projection on an opposite end and a pivot point disposed therebetween, the crank being operable mounted between the exit end of the sleeve and the proximate opening; and a pellet propulsor which accepts a pellet from the sleeve and urges movement of the pellet through the tubing to be cleaned, whereby operation of the crank causes the first projection to unblock the exit end of the sleeve allowing movement of a pellet from the sleeve into the propulsor prior to propulsion of the pellet through the tubing, while inserting the second projection into the proximate opening thereby preventing premature movement of a second pellet into the propulsor.

Another advantage of the present invention is to provide a method for cleaning interior passages of fluid carrying tubing using one or more automatically loaded foam cleaning pellets, by filling a reservoir of a pellet launcher with a plurality of cleaning pellets, the reservoir having a pivotal crank which permits one pellet at a time to be dispensed upon command; actuating the crank to automatically load a pellet into the launcher; and launching the pellet into the interior passage to be cleaned.

### BRIEF DESCRIPTION OF THE DRAWINGS

FIG. 1 shows an automatic loader according to a presently preferred embodiment of the invention;

FIG. 2 shows an operative position of an automatic loader according to a presently preferred embodiment of the invention;

FIG. 3 shows a rear view of an automatic loader according to a presently preferred embodiment of the invention.

### DETAILED DESCRIPTION OF THE PRESENTLY PREFERRED EMBODIMENTS

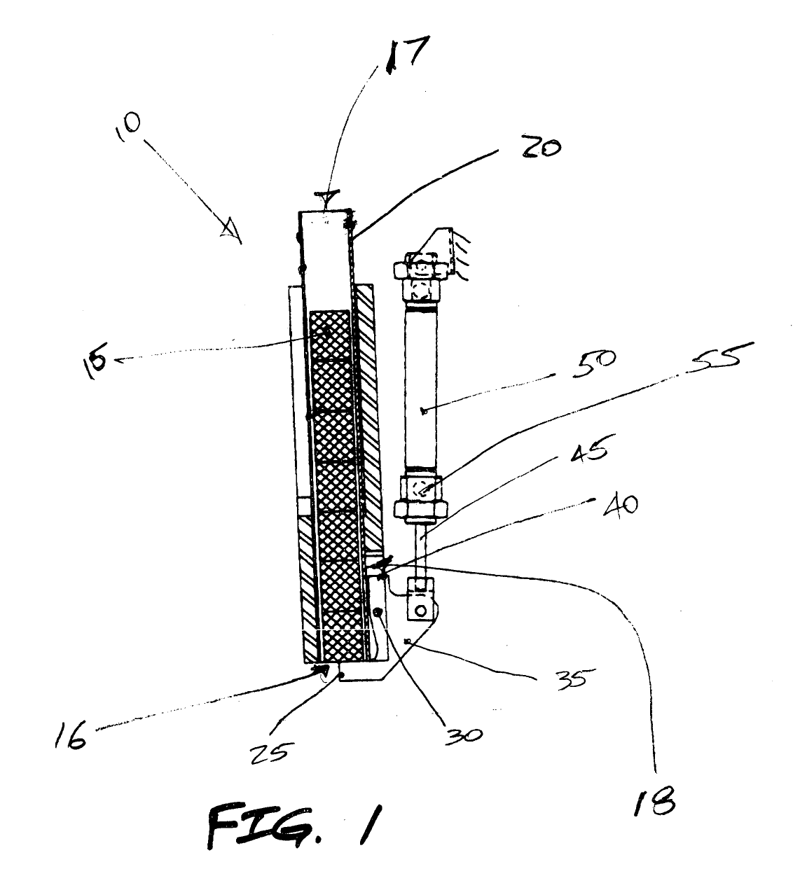

FIG. 1 shows an automatic loader 10 (also referred to as an autoloader) for a foam pellet launcher (not shown), in accordance with a presently preferred embodiment of the invention.

Main components of the autoloader 10 include a cylindrically shaped feed-tube 20, an L-shaped crank 35, and a pneumatic ram 45, actuated by a pneumatic cylinder 50.

Pneumatic cylinder 50 is supplied from a source of comp-ressed air via a pneumatic inlet 55. Crank 35 is fixed about a pivot point 30, and cylinder 50 operates crank 35 via pneumatic ram 45.

Crank 35 includes a lower projection or end 25 and an upper projection or end 40. One projection each is situation on each extremity of the L-shape of the crank 35. When urged to pivot by the ram 45 under control of the pneumatic cylinder 50, the upper projection or end 25 and lower projection or end 40 freely move in unison about pivot point 30.

Sleeve or feed-tube 20 has at its upper end and opening 17 which receives a supply of cleaning pellets 15. The lower end of sleeve or feed-tube 20 has an exit end 16 out of which the cleaning pellets 15 emerge. Adjacent to exit end 16, at a location thereabove, is a proximate opening 18 whose function and purpose will be described later.

Cleaning pellets 15 are cylindrical in shape, uniform in size, made of an appropriate foam rubber material, and have a diameter comparable to the diameter of a fluid carrying tubing to be cleaned.

Sleeve or feed-tube 20 has a diameter corresponding to the diameter of the pellets 15 to be held therein. The length of feed-tube 20 is sufficient such that a significant number of pellets 15 can be held therein to achieve desired efficient and economic cleaning of fluid carrying tubing without need for constant replenishment of pellets 15.

A full load of foam cleaning pellets 15 are vertically stacked end-to-end into sleeve or feed-tube 20 through supply opening 17. Feed-tube 20 serves as a reservoir for the pellets 15 and holds them, while they await ejection from exit opening 16 upon command. Once a pellet 15 emerges from sleeve or feed-tube 20 via exit opening 16, it is lead directly into the launch chamber of a pneumatic launch device (not shown), which will then propel the pellet 15 through fluid carrying tubing to be cleaned. Pellets 15 are launched in response to instruction from an operator via a control panel (not shown).

A typical cleaning system uses a computerized arrangement of air logic controls to synchronize and execute all functions, such as regulating pneumatic pressure and launch of cleaning pellets.

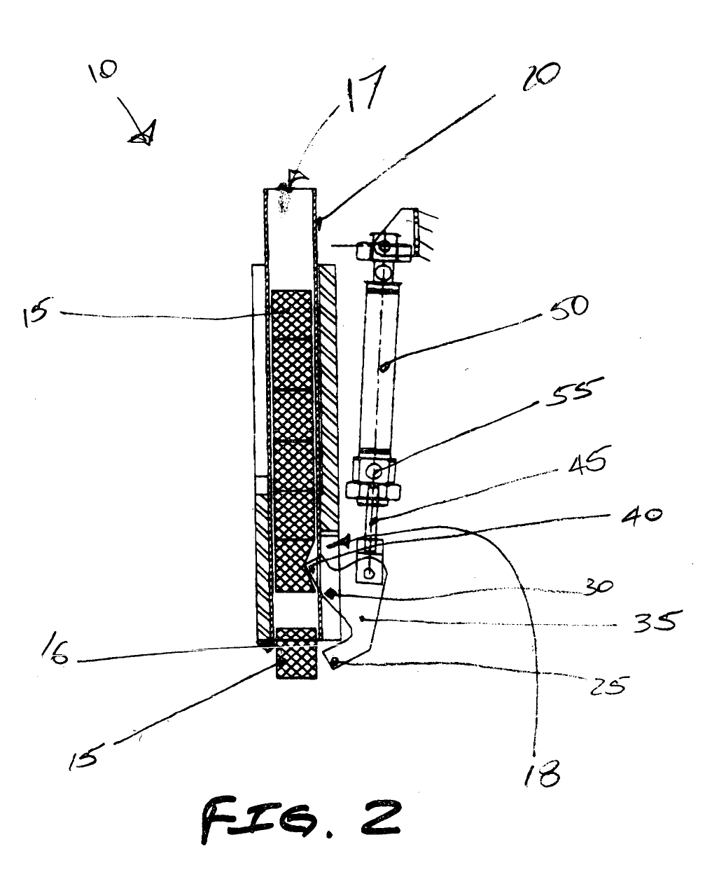

FIG. 2 shows the autoloader 10 as a foam cleaning pellet 15, held within feed-tube 20, is prepared to emerge from exit opening 16 of the tube 20, in accordance with a presently preferred embodiment of the invention.

In a ready position, lower projection 25 blocks the lower or exit end 16 of the feed-tube 20 preventing emergence of a pellet 15 from the sleeve 20. The stack of pellets 15 rest on the projection 25 when the crank 35 is the ready position.

In operation, when crank 35 is moved about pivot 30 by actuation of ram 45, lower projection or end 25 moves away from the proximate opening 18 but does not clear before the upper projection or end 40 above it moves into the feed-tube 20 through proximate opening 18 and jams the next nearest pellet 15 thereabove.

When the lower projection or end 25 is clear of exit opening 16, only one pellet 15 falls, due to the influence of gravity, out of exit end 16. No other pellet 15 falls out of exit 16 of feed-tube 20 because the nearest and adjacent pellet in tube 20 is jammed against interior side wall of sleeve feed-tube 20 by upper projection or end 40, which has now pivotally intruded into proximate opening 18, as shown in FIG. 2.

When the crank 35 is rotated the other way by reverse operation of ram 45, the next pellet 15 adjacent to the pellet previously passing through exit end 16, is released from contact with upper projection or end 40 of crank 35. At the same time, lower projection or end 25 is in position to again block exit end 16 of feed-tube 20, thereby allowing release of only one pellet at a time and preventing premature release of another pellet until called for by the cleaning system operator.

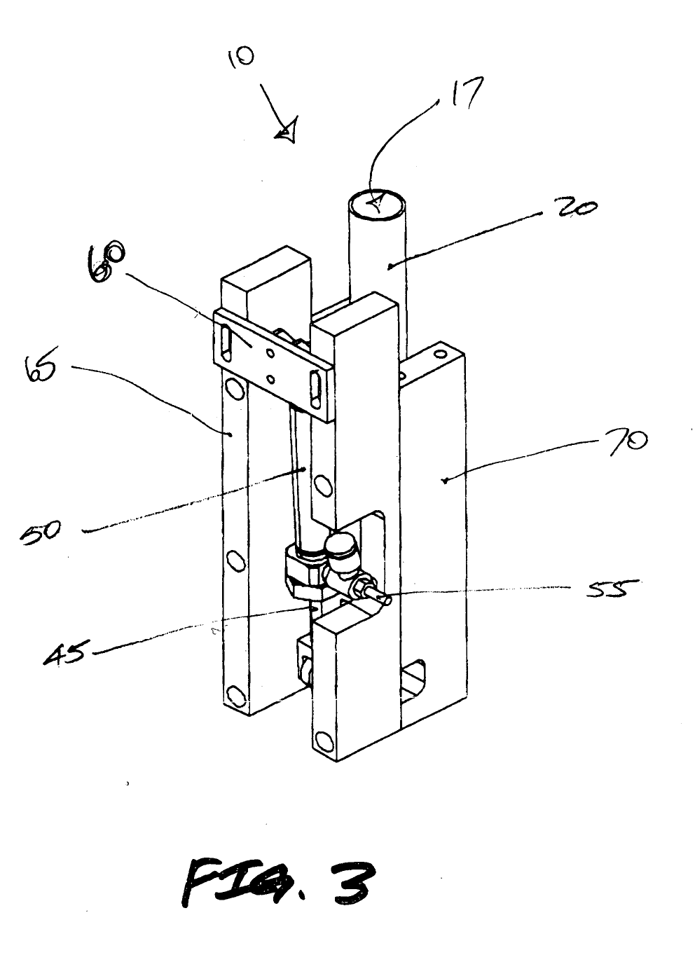

Turning now to FIG. 3, where autoloader 10 is shown in a configuration adaptable for attachment to the loading port of a typical commercially available bench-top pellet gun, such as a unit made by Ultra-Clean Technologies, Inc. of Bridgeton, N.J.

Adaptation of the autoloader 10 for attachment to a commercially available pellet cleaning system requires suitable modifications for mechanical support, such as mounting brackets 60, 65, and 70.

All major components of the autoloader 10, such as, sleeve or feed tube 20, crank 35, pneumatic ram 45, pneumatic cylinder 50, and pneumatic inlet 55, and their respective operation, remain as described above with respect to FIG. 1 and FIG. 2.

Proper mounting of the autoloader 10 onto a commercially available pellet cleaning system requires that upon emerging from the exit end 16 of sleeve 20, pellets 15 can be smoothly conducted into a loading port of the commercial unit for propulsion through the tubing to be cleaned.

The air logic used to control propulsion of the pellet 15 through the tubing to be cleaned is altered to coordinate operation of the autoloader 10, thereby ensuring smooth and automatic operation of the process without need for manual loading of pellets 15 into the launcher one at a time.

Although the presently preferred embodiment of the autoloader 10 and cleaning system are discussed with regard to pneumatic operation, it should be noted that any other form of fluid power, such as hydraulic power, will achieve successful operation and desired results. Similarly, various other suitable forms of mechanical power are also conceivable for effective use to bring about efficient operation.

Accordingly, the description for the present invention is to be construed as illustrative only and is for the purpose of teaching those skilled in the art the best mode of carrying out the invention. The details may be varied substantially without departing from the spirit of the invention, and the exclusive use of all modifications with are within the scope of the appended claims is reserved.

1. An automatic loader for a foam pellet cleaning system including a pellet propeller, the automatic loader comprising:
a vertically mounted, tubular-shaped multiple pellet reservoir having an entrance port at its top end, an exit port on its lower end, and an opening proximate the exit port; and
a L-shaped crank pivotally mounted between the exit port and the proximate opening, the crank having a first end operable to block discharge of a pellet from the exit end of the reservoir, and a second end operable for intrusion into the proximate opening; such that pivotal operation of the crank causes the first end to unblock the exit end of the reservoir allowing discharge of a pellet from the reservoir into the pellet propeller, while simultaneously intruding the second end into the proximate opening to prevent premature discharge of a second pellet from the exit end into the propeller.

2. The automatic loader of claim 1, wherein the crank is operated by pneumatic pressure.

3. The automatic loader of claim 1, wherein the cleaning pellets are stacked in the reservoir in an end-to-end fashion.

4. A method for operating an automatic pellet loader for a foam pellet cleaning system having a pellet launcher, the method comprising the steps of:
filling a cleaning pellet dispenser with a plurality of pellets, the dispenser having a pivotal crank adjacent its dispensing end;
actuating the crank to permit one pellet at a time to be dispensed from the dispenser upon command; and
loading a dispensed pellet into the launcher of the cleaning system.

5. The method of claim 4, wherein the crank is operated by pneumatic pressure.

6. The method of claim 4, wherein the crank is operated by fluid pressure.

7. A system for cleaning interior passages of fluid carrying tubing using foam pellets comprising a vertically mounted pellet retaining sleeve having an entrance port at its top end, an exit port on its lower end, and an opening proximate the exit port; an L-shaped crank having a first projection on one end which blocks discharge of a pellet from the exit end of the sleeve, a second projection on an opposite end and a pivot point disposed therebetween, the crank being operable mounted between the exit end of the sleeve and the proximate opening; and a pellet propulsor which accepts a pellet from the sleeve and urges movement of the pellet through the tubing to be cleaned, whereby operation of the crank causes the first projection to unblock the exit end of the sleeve allowing movement of a pellet from the sleeve into the propulsor for propulsion through the tubing, while inserting the second projection into the proximate opening thereby preventing premature movement of a second pellet into the propulsor.

8. The system of claim 7, wherein the crank is operated by a pneumatic cylinder and ram arrangement.

9. The system of claim 7, wherein the crank is operated by fluid pressure.

10. The system of claim 7, wherein the pellet is propelled by fluid force.

11. The system of claim 10, wherein the fluid force is pneumatic pressure.

12. A method for cleaning interior passages of fluid carrying tubing using one or more automatically loaded foam cleaning pellets, the method comprising the steps of:
filling a reservoir of a pellet launcher with a plurality of cleaning pellets, the reservoir having a pivotal crank which permits one pellet at a time to be dispensed upon command;
actuating the crank to automatically load a pellet into the launcher; and
launching the pellet into the interior passageway to be cleaned.

13. The method of claim 12, wherein the step of actuating the crank comprises using pneumatic pressure.

14. The method of claim 12, wherein the step of actuating the crank comprises using fluid pressure.

15. The method of claim 12, wherein the step of launching the pellet comprises using pneumatic pressure.

16. The method of claim 12, wherein the step of launching the pellet comprises using fluid pressure.
